(19) United States
(12) Patent Application Publication
(10) Pub. No.: US 2002/0029142 A1
(43) Pub. Date: Mar. 7, 2002

(54) Vocoding method in all internet protocol (IP) network

(76) Inventor: Yeon-Sang Koo, Ichon-Shi (KR)

Correspondence Address: BAKER BOTTS L.L.P., 30 ROCKEFELLER, 44TH FLOOR, NEW YORK, NY, 10112-4498, US

(21) Appl. No.: 09/785,061

(22) Filed: Feb. 16, 2001

(30) Foreign Application Priority Data
Sep. 5, 2000 (KR) 2000-52486

(51) Int. Cl. G10L 19/12; G10L 21/00

(52) U.S. Cl. 704/221

(57) ABSTRACT

A method for vocoding in an ALL IP network including one or more circuit networks, one or more radio access networks and one or more packet networks includes the steps of: determining if a first vocoding algorithm of a sending terminal is the same as a second vocoding algorithm of a destination terminal; if the first vocoding algorithm is the same as the second vocoding algorithm, bypassing voice data from the sending terminal and transmitting the bypassed voice data to the destination terminal; if the first vocoding algorithm is not the same as the second vocoding algorithm, determining if the sending terminal is a mobile terminal; if the sending terminal is the mobile terminal, at a first radio access network (RAN) gateway coupled to the sending mobile terminal, vocoding the voice data at a data rate of the circuit network to thereby generate first vocoded data and transmitting the first vocoded data to a second RAN gateway coupled to a destination mobile terminal; and at the second RAN gateway, vocoding the first vocoded data to be compatible with the second vocoding algorithm of the destination mobile terminal to thereby generate second vocoded data and transmitting the second vocoded data to the destination mobile terminal.

### FIELD OF THE INVENTION

This invention relates to a method for vocoding in a communication system; and more particularly, to a method for vocoding to be compatible with a vocoding algorithm stored in a destination mobile station in an All-IP network and a computer readable record media storing instructions for performing the method.

### DESCRIPTION OF THE PRIOR ART

FIGS. 1A and 1B are block diagrams illustrating a conventional synchronous mobile communication network including a vocoder.

A vocoder is generally placed at an interface point between a base station controller (BSC) and a mobile switching center (MSC).

As shown in FIG. 1A, when a sending mobile station (MS) is communicating with a destination mobile station (MS) whose vocoding algorithm is the same as that of the sending mobile station (MS), the vocoder performs a bypass instead of vocoding because the mobile stations are compatible with a 64 kbps vocoding.

As shown in FIG. 1B, in case a mobile subscriber is communicating with a wire subscriber of a public switched telephone network (PSTN), voice data are vocoded by an enhanced variable rate speech codec (EVRC) at a mobile station, are vocoded at 64 kbps by a vocoder 104 of a base station controller (BSC) 103 and then are transmitted to the PSTN 106 via a mobile switching center (MSC) 105.

In these days, a mobile communication network tends to be evolved to an ALL internet protocol (IP) network which is configured based on an internet protocol (IP) and in which essentially packet data transmission is performed. In this case, it is required to adjust a function and a place of the vocoder in order to provide a voice data service efficiently, otherwise there is a problem that an overhead between interfaces is occurred to thereby increase a traffic load.

### SUMMARY OF THE INVENTION

It is an object of the present invention to provide a method for vocoding in an ALL IP network including one or more circuit networks, one or more radio networks and one or more packet networks to thereby reduce an overhead related to a vocoder in a mobile communication network and provide an efficient traffic management.

In accordance with an aspect of the present invention, there is provided a method for vocoding in an ALL IP network including one or more circuit networks, one or more radio access networks and one or more packet networks, the method comprising the steps of: a) determining if a first vocoding algorithm of a sending terminal is the same as a second vocoding algorithm of a destination terminal; b) if the first vocoding algorithm is the same as the second vocoding algorithm, bypassing voice data from the sending terminal and transmitting the bypassed voice data to the destination terminal; c) if the first vocoding algorithm is not the same as the second vocoding algorithm, determining if the sending terminal is a mobile terminal; d) if the sending terminal is the mobile terminal, at a first radio access network (RAN) gateway coupled to the sending mobile terminal, vocoding the voice data at a data rate of the circuit network to thereby generate first vocoded data and transmitting the first vocoded data to a second RAN gateway coupled to a destination mobile terminal; and e) at the second RAN gateway, vocoding the first vocoded data to be compatible with the second vocoding algorithm of the destination mobile terminal to thereby generate second vocoded data and transmitting the second vocoded data to the destination mobile terminal.

### BRIEF DESCRIPTION OF THE DRAWINGS

Other objects and aspects of the invention will become apparent from the following description of the embodiments with reference to the accompanying drawings, in which:

FIGS. 1A and 1B are block diagrams illustrating a conventional synchronous mobile communication network including a vocoder;

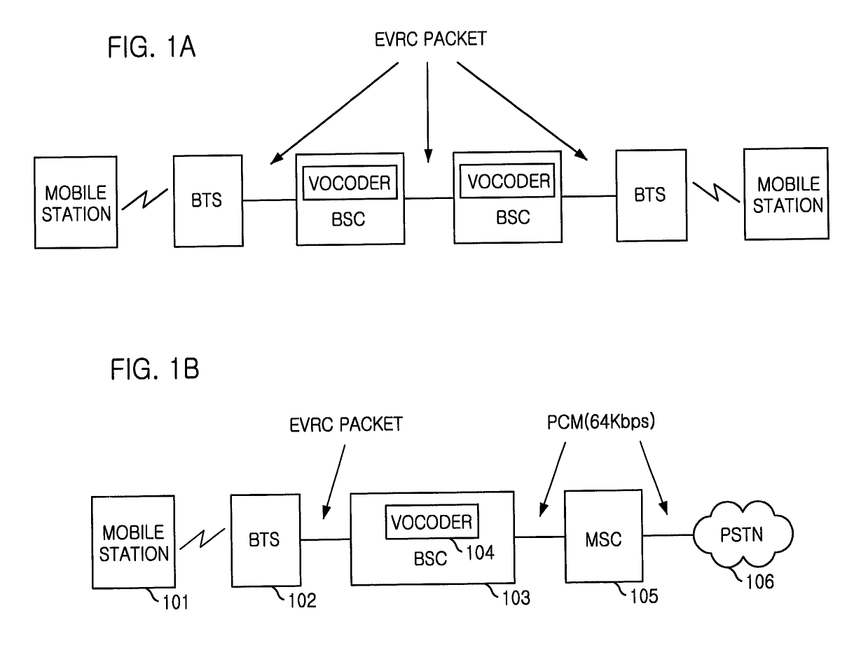

FIG. 2 shows a position of a vocoder in an ALL IP network in case one vocoding algorithm is used in accordance with the present invention;

FIG. 3 shows a configuration of an ALL IP network including a vocoder in case two or more vocoding algorithms are used in accordance with the present invention;

FIG. 4 shows a configuration of an ALL IP network including a transcoder in case two or more vocoding algorithms are used in accordance with the present invention;

FIG. 5 is a block diagram illustrating a vocoding procedure in sending/destination radio access network (RAN) gateways in case two or more vocoding algorithms are used in accordance with the present invention;

FIG. 6 is a block diagram illustrating a vocoding procedure in one of sending/destination radio access network (RAN) gateways in case two or more vocoding algorithms are used in accordance with the present invention;

FIG. 7 is a block diagram illustrating another vocoding procedure in one of sending/destination radio access network (RAN) gateways in case two or more vocoding algorithms are used in accordance with the present invention; and

FIG. 8 is a flow chart illustrating a method for vocoding voice data in an ALL IP network in accordance with the present invention.

### DETAILED DESCRIPTION OF THE PREFERRED EMBODIMENTS

A vocoder is placed in a radio access network (RAN) in a conventional system. On the other hand, in an ALL IP network, the vocoder is posed in a circuit gateway interworking with a public switched telephone network (PSTN) since actually, there is no need to perform a function of the vocoder except for a case of performing the function for a voice data service between a subscriber of the existing PSTN and a mobile subscriber.

However, in case a voice vocoding algorithm of an air interface is defined by at least one specification or in case one or more algorithms are operated in the ALL IP network if necessary, the vocoder is to be employed. In this case, the vocoder is placed in the radio access network (RAN) to which is directly coupled to an ALL IP core network. A position of the vocoder is not fixed but changeable depending on a degree of evolution to the ALL IP network.

As network elements get structured based on an internet protocol (IP) due to an evolution to the ALL IP network, a gateway is needed to interwork with existing networks. The gateway includes a circuit gateway, a roaming gateway, a packet gateway or the like. The circuit gateway is used for interworking with the PSTN, the roaming gateway for interworking with an existing mobile communication network, i.e., a second-generation network and the packet gateway for interworking with an internetork.

It is assumed that a position of the vocoder in the ALL IP network can be sorted into two cases. A position of the vocoder for voice data depends on the number of the vocoding algorithm in the ALL IP network. That is to say, the position of the vocoder can be adjusted depending on whether one algorithm is used or two or more algorithms.

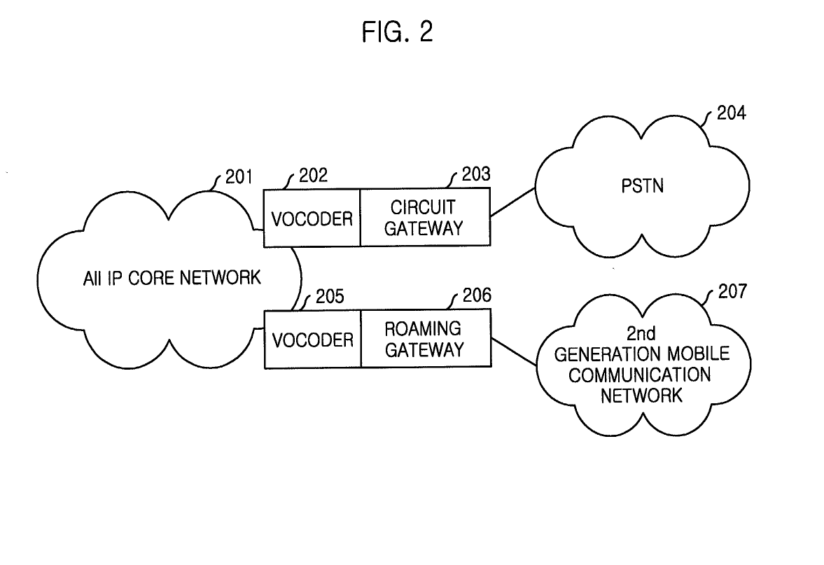

FIG. 2 shows a position of a vocoder in an ALL IP network in case one vocoding algorithm is used in accordance with the present invention.

As shown in the drawing, in case one vocoding algorithm is used, a vocoder 202 is placed in a circuit gateway 203 to which is coupled to a public switched telephone network (PSTN) 204 and another vocoder 205 is located in a roaming gateway 206 to which is coupled to a second generation mobile communication network 207.

Voice data transmitted/received between mobile stations are not vocoded but bypassed in an ALL IP core network 201.

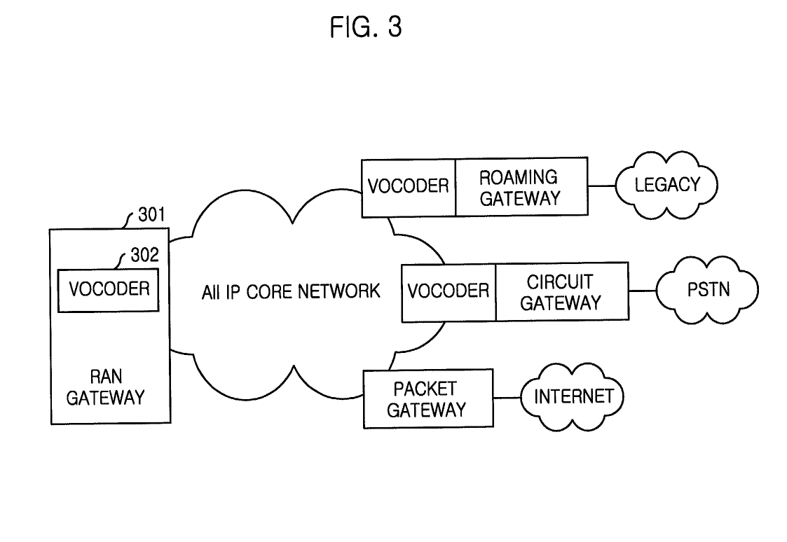

FIG. 3 shows a configuration of an ALL IP network including a vocoder in case two or more vocoding algorithms are used in accordance with the present invention.

In an ALL IP network, a radio access network (RAN) is interworking with the PSTN, an internetwork or the like via a core network and corresponding gateways. In this case, it depends on what network element is designated as an IP node to determine via what route the RAN will interwork.

A network in which two or more vocoding algorithms are performed includes a network in which one vocoding algorithm is performed. Also, a function of the vocoder is added in each mobile station in order to transmit/receive voice data between mobile stations in the ALL IP network.

Referring to FIG. 3, the vocoder 302 is placed in a RAN gateway 301. In case a same vocoding algorithm is used between mobile stations, voice data are bypassed without being vocoded in the same way as the existing system. If different vocoding algorithms are used between mobile stations, the voice data are converted to 64 kbps data in a sending RAN gateway using a vocoder compatible with a sending mobile station and in a destination RAN gateway, are vocoded compatible with a destination mobile station and then transmitted to the destination mobile station.

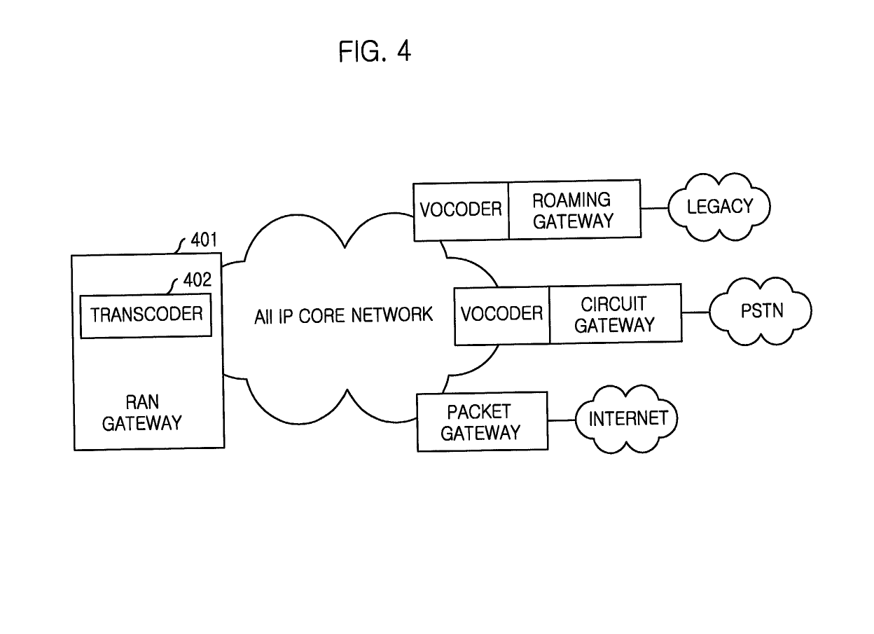

FIG. 4 shows a configuration of an ALL IP network including a transcoder in case two or more vocoding algorithms are used in accordance with the present invention.

Referring to the drawing, a transcoder 402 is placed in sending/destination RAN gateway 401. In case different vocoding algorithms are used between mobile stations, the voice data are transcoded according to a vocodig algorithm. In this case, the vocoding operation can be performed by make better use of an existing vocoder or by using a new transcoder algorithm.

In case of using the existing vocoder better, there is a disadvantage that a procedure of conversion to 64 kbps is needed and vocoding should be performed two times, however an advantage that an existing system can be employed as it is.

In case of using the new transcoder algorithm, the transcoder is located in the sending/destination RANs and vocoding is performed in one of the two RANs irrespective of transmitting/receiving.

Information about which vocoder will be operated is based on vocoding information among lots of information which are transmitted from a mobile station at call setup time. The information is determined by a call control part in allocating a vocoder resource and is provided to the RAN.

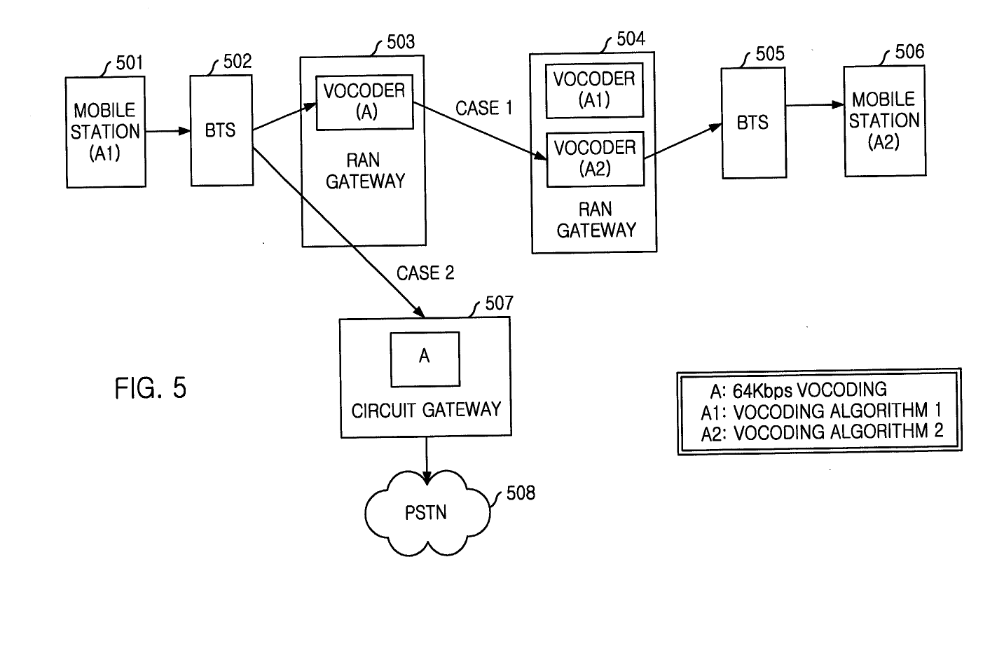

FIG. 5 is a block diagram illustrating a vocoding procedure in sending/destination radio access network (RAN) gateways in case two or more vocoding algorithms are used in accordance with the present invention.

AS aforementioned, in case a same vocoding algorithm is used between mobile stations, voice data are bypassed without being vocoded.

It is assumed that an “A1” vocoding algorithm is stored in a sending mobile station (MS) 501 and an “A2” vocoding algorithm in a destination mobile station 506 (a case 1 in FIG. 5).

First, voice data are vocoded according to the “A1” vocoding algorithm of the sending MS 501 and are received at a RAN gateway 503 via a base transceiver station (BTS) 502. Upon reception of the voice data vocoded according to the “A1” algorithm, a vocoder of the RAN gateway 503 performs vocoding the voice data to 64 kbps data.

At a destination RAN gateway which includes a vocoder compatible with the destination mobile station (MS) 506, the received voice data are vocoded according to the “A2” vocoding algorithm and are transmitted to the destination mobile MS 506 via a BTS 505.

In case the mobile station communicates with a subscriber of a public switched telephone network (PSTN), i.e., in case the MS 501 of the “A1” vocoding algorithm communicates with a subscriber of a PSTN 508 (a case 2 in FIG. 5), voice data are bypassed to a circuit gateway 507 without being vocoded. At the circuit gateway 507, the voice data are vocoded to 64 kbps data and transmitted to the subscriber of the PSTN 508.

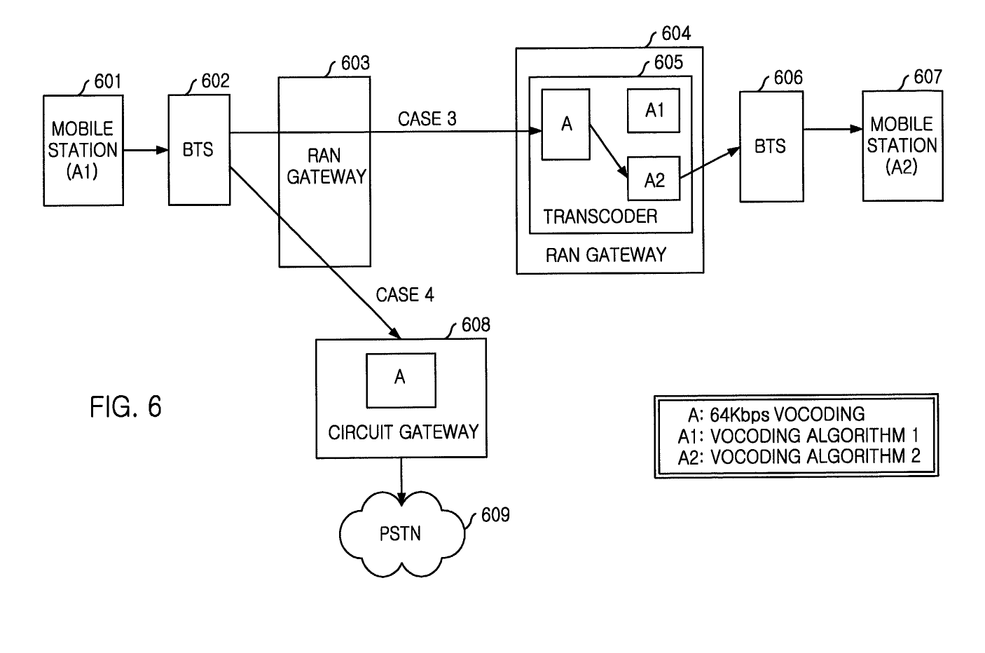

FIG. 6 is a block diagram illustrating a vocoding procedure in one of sending/destination radio access network (RAN) gateways in case two or more vocoding algorithms are used in accordance with the present invention.

A vocoding procedure illustrated in FIG. 6 is different that in FIG. 5 in that vocoding is performed two times at one RAN gateway.

Transcoding can be performed at any one of sending/destination RAN gateways using an existing vocoder. A 64 kbps interface is in a RAN in which a transcoder 605 is placed. In this configuration, there is an advantage of making use of an existing system to the maximum.

It is assumed that an “A1” vocoding algorithm is stored in a sending mobile station (MS) 601 and an “A2” vocoding algorithm in a destination mobile station (MS) 607 (a case 3 in FIG. 6), and a transcoder 605 is placed in a destination RAN gateway 604.

Voice data are vocoded to 64 kbps data at the transcoder 605 included in the destination RAN gateway 604, are vocoded in conformity with a vocoding algorithm of the destination MS 607, i.e., in conformity with the “A2” vocoding algorithm and are transmitted to the destination MS 607.

In case the sending mobile station (MS) 601 communicates with a subscriber of a public switched telephone network (PSTN) 609 (a case 4 in FIG. 6), the vocoding procedure is the same as the procedure for the case 2 illustrated in FIG. 5.

That is to say, the voice data are bypassed to a circuit gateway 608 without being vocoded. At the circuit gateway 608, the voice data are vocoded to 64 kbps data and transmitted to the subscriber of the PSTN 609.

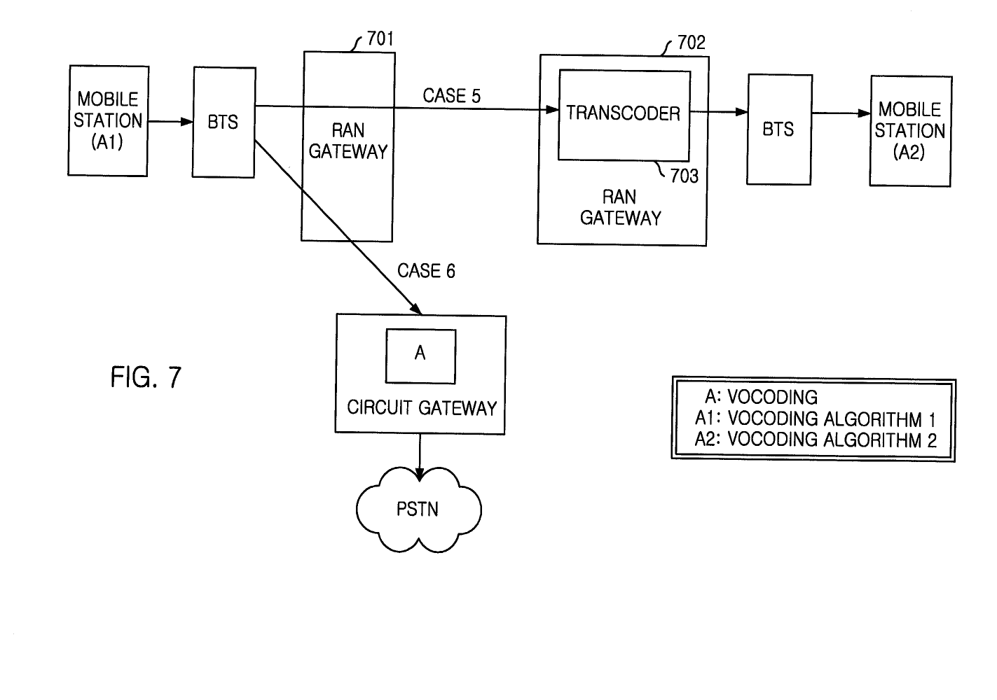

FIG. 7 is a block diagram illustrating another vocoding procedure in one of sending/destination radio access network (RAN) gateways in case two or more vocoding algorithms are used in accordance with the present invention.

A new transcoder can be located in anyone of sending/destination radio access network (RAN) gateways 701 and 702. As shown in FIG. 7, the new transcoder is placed in the destination RAN gateway 702.

According to a vocoding algorithm of the new transcoder 703, voice data needs not to be vocoded to 64 kbps data. Instead, different vocoding algorithms for voice data which are included in an ALL IP are mutually converted.

At the transcoder 703 included in the destination RAN gateway 702, the voice data are vocoded in conformity with a vocoding algorithm of the destination MS, i.e., in conformity with the “A2” vocoding algorithm and are transmitted to the destination MS.

In case the sending mobile station (MS) communicates with a subscriber of a public switched telephone network (PSTN) (a case 6 in FIG. 7), the vocoding procedure is the same as the procedure for the case 2 illustrated in FIG. 5.

That is to say, the voice data are bypassed to a circuit gateway without being vocoded. At the circuit gateway, the voice data are vocoded to 64 kbps data and transmitted to the subscriber of the PSTN.

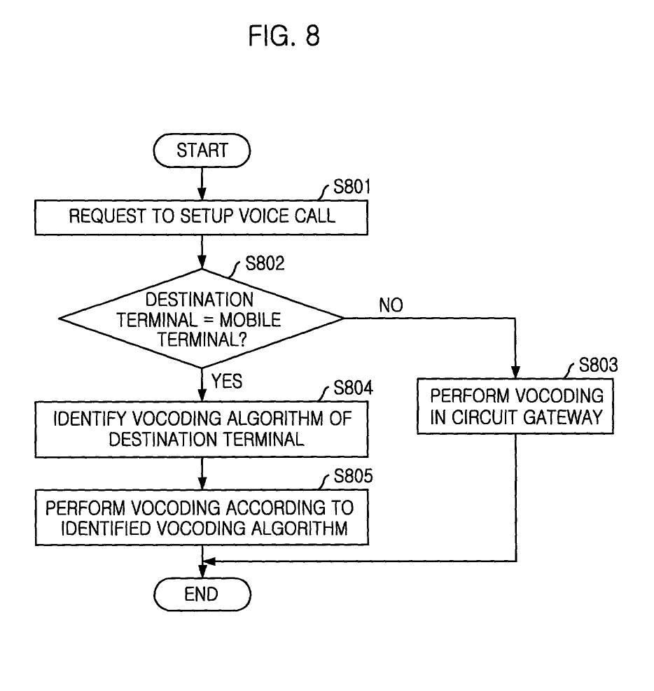

FIG. 8 is a flow chart illustrating a method for vocoding voice data in an ALL IP network in accordance with the present invention.

At the step S801, a sending mobile station (MS) requests a radio access network (RAN) to set up a voice call.

At the step S802, the RAN determines whether a destination subscriber is a mobile subscriber or a PSTN subscriber.

If the destination subscriber is the PSTN subscriber, at the step S803, the voice data are vocoded to 64 kbps data in a circuit gateway and are transmitted to a destination mobile station (MS).

If the destination subscriber is the mobile subscriber, at the step S804, the RAN identifies a vocoding algorithm stored in the destination mobile station (MS).

At the step S805, if a vocoding algorithm stored in the sending MS is the same as the vocoding algorithm of the destination MS, the voice data are bypassed without performing a vocoding conversion. Otherwise, at a vocoder in a RAN gateway, the voice data are vocoded compatible with the vocoding algorithm of the destination MS and are transmitted to the destination MS.

By performing the method for vocoding the voice data in accordance with the present invention, there is provided an advantageous effect that it is possible to reduce an overhead related to the vocoder and to manage a traffic efficiently.

Although the preferred embodiments of the invention have been disclosed for illustrative purpose, those skilled in the art will appreciate that various modifications, additions, and substitutions are possible, without departing from the scope and sprit of the invention as disclosed in the accompanying claims.

What is claimed is:

1. A method for vocoding in an ALL IP network including one or more circuit networks, one or more radio access networks (RAN) and one or more packet networks, the method comprising the steps of:
a) determining if a first vocoding algorithm of a sending terminal is the same as a second vocoding algorithm of a destination terminal;
b) if the first vocoding algorithm is the same as the second vocoding algorithm, bypassing voice data from the sending terminal and transmitting the bypassed voice data to the destination terminal;
c) if the first vocoding algorithm is not the same as the second vocoding algorithm, determining if the sending terminal is a mobile terminal;
d) if the sending terminal is the mobile terminal, at a first radio access network (RAN) gateway coupled to the sending mobile terminal, vocoding the voice data at a data rate of the circuit network to thereby generate first vocoded data and transmitting the first vocoded data to a second RAN gateway coupled to a destination mobile terminal; and
e) at the second RAN gateway, vocoding the first vocoded data to be compatible with the second vocoding algorithm of the destination mobile terminal to thereby generate second vocoded data and transmitting the second vocoded data to the destination mobile terminal.

2. The method as recited in claim 1, wherein the step d) further includes the step of:
f) if the sending terminal is a terminal for the circuit network, at a circuit gateway, vocoding the voice data at data rate of the circuit network.

3. The method as recited in claim 1, wherein the second RAN gateway includes:
a first vocoder storing the first vocoding algorithm therein; and
a second vocoder storing the second vocoding algorithm therein.

4. A method for vocoding in an ALL IP network including one or more circuit networks, one or more radio access networks (RAN) and one or more packet networks, the method comprising the steps of:
a) determining if a first vocoding algorithm of a sending terminal is the same as a second vocoding algorithm of a destination terminal;
b) if the first vocoding algorithm is the same as the second vocoding algorithm, bypassing voice data from the sending terminal and transmitting the bypassed voice data to the destination terminal;
c) if the first vocoding algorithm is not the same as the second vocoding algorithm, determining if the sending terminal is a mobile terminal;
d) if the sending terminal is the mobile terminal, at a first radio access network (RAN) gateway coupled to the sending mobile terminal, vocoding the voice data at a data rate of the circuit network to thereby generate first vocoded data;
e) at the first RAN gateway, vocoding the first vocoded data to be compatible with the second vocoding algorithm of the destination mobile terminal to thereby generate second vocoded data; and
f) transmitting the second vocoded data to the destination mobile terminal.

5. The method as recited in claim 4, wherein the first RAN gateway includes:
a first vocoding unit for vocoding the voice data at the data rate of the circuit network;
a first vocoder storing the first algorithm therein; and
a second vocoder storing the second algorithm therein.

6. The method as recited in claim 4, wherein the step d) further includes the steps of:
g) if the sending terminal is the mobile terminal, transmitting the voice data to a second radio access network (RAN) gateway coupled to the destination mobile terminal;
h) at the second RAN gateway, vocoding the voice data at a data rate of the circuit network to thereby generate the first vocoded data;
i) at the second RAN gateway, vocoding the first vocoded data to be compatible with the second vocoding algorithm of the destination mobile terminal to thereby generate the second vocoded data; and
j) transmitting the second vocoded data to the destination mobile terminal.

7. The method as recited in claim 6, wherein the second RAN gateway includes:
a second vocoding unit for vocoding the voice data at the data rate of the circuit network;
a third vocoder storing the first algorithm therein; and
a fourth vocoder storing the second algorithm therein.

8. The method as recited in claim 4, wherein the step d) another further includes the step of:
k) if the sending terminal is a terminal for the circuit network, at a circuit gateway, vocoding the voice data at data rate of the circuit network.

9. A computer-readable record media storing instructions for performing a method for vocoding in an ALL IP network including one or more circuit networks, one or more radio access networks (RAN) and one or more packet networks, the method comprising the steps of:
a) determining if a first vocoding algorithm of a sending terminal is the same as a second vocoding algorithm of a destination terminal;
b) if the first vocoding algorithm is the same as the second vocoding algorithm, bypassing voice data from the sending terminal and transmitting the bypassed voice data to the destination terminal;
c) if the first vocoding algorithm is not the same as the second vocoding algorithm, determining if the sending terminal is a mobile terminal;
d) if the sending terminal is the mobile terminal, at a first radio access network (RAN) gateway coupled to the sending mobile terminal, vocoding the voice data at a data rate of the circuit network to thereby generate first vocoded data and transmitting the first vocoded data to a second RAN gateway coupled to a destination mobile terminal; and
e) at the second RAN gateway, vocoding the first vocoded data to be compatible with the second vocoding algorithm of the destination mobile terminal to thereby generate second vocoded data and transmitting the second vocoded data to the destination mobile terminal.

10. The computer-readable record media as recited in claim 9, wherein the step d) further includes the step of:
f) if the sending terminal is a terminal for the circuit network, at a circuit gateway, vocoding the voice data at data rate of the circuit network.

11. A computer-readable record media storing instructions for performing a method for vocoding in an ALL IP network including one or more circuit networks, one or more radio access networks (RAN) and one or more packet networks, the method comprising the steps of:
a) determining if a first vocoding algorithm of a sending terminal is the same as a second vocoding algorithm of a destination terminal;
b) if the first vocoding algorithm is the same as the second vocoding algorithm, bypassing voice data from the sending terminal and transmitting the bypassed voice data to the destination terminal;
c) if the first vocoding algorithm is not the same as the second vocoding algorithm, determining if the sending terminal is a mobile terminal;
d) if the sending terminal is the mobile terminal, at a first radio access network (RAN) gateway coupled to the sending mobile terminal, vocoding the voice data at a data rate of the circuit network to thereby generate first vocoded data;
e) at the first RAN gateway, vocoding the first vocoded data to be compatible with the second vocoding algorithm of the destination mobile terminal to thereby generate second vocoded data; and
f) transmitting the second vocoded data to the destination mobile terminal.

12. The computer-readable record media as recited in claim 11, wherein the step d) further includes the steps of:
g) if the sending terminal is the mobile terminal, transmitting the voice data to a second radio access network (RAN) gateway coupled to the destination mobile terminal;
h) at the second RAN gateway, vocoding the voice data at a data rate of the circuit network to thereby generate the first vocoded data;
i) at the second RAN gateway, vocoding the first vocoded data to be compatible with the second vocoding algorithm of the destination mobile terminal to thereby generate the second vocoded data; and
j) transmitting the second vocoded data to the destination mobile terminal.

13. The computer-readable record media as recited in claim 12, wherein the step d) another further includes the step of:
k) if the sending terminal is a terminal for the circuit network, at a circuit gateway, vocoding the voice data at data rate of the circuit network.
